(19) United States
(12) Patent Application Publication
(10) Pub. No.: US 2010/0299463 A1
(43) Pub. Date: Nov. 25, 2010

(54) Player Device Enabling Fast Deletion and Access

(76) Inventor: Chun-Te HAO, Sanchong City (TW)

Correspondence Address: Muncy, Geissler, Olds & Lowe, PLLC, 4000 Legato Road, Suite 310, FAIRFAX, VA, 22033, US

(21) Appl. No.: 12/258,948

(22) Filed: Oct. 27, 2008

(51) Int. Cl. G06F 13/38; G06F 13/00

(52) U.S. Cl. 710/63; 710/302

(57) ABSTRACT

The present invention relates to a player device enabling fast deletion and access, in which a player device includes a digital billboard and a storage device. A transmission interface, provided with a USB slot at one end, extends from one side of the digital billboard, and one end of the storage device is equipped with a USB connector. Moreover, a circuit board, disposed within the storage device, is equipped with a control unit able to automatically delete and store multimedia files within the digital billboard and a database unit able to store multimedia files. Accordingly, when the user needs to replace the advertisement contents within the digital billboard, then, the storage device of the present invention need only be inserted into the transmission interface of the digital billboard equipped with an updating program compatible with the storage device, and after a preset time the updating process is completed.

### BACKGROUND OF THE INVENTION

(a) Field of the Invention

The present invention provides a player device enabling fast deletion and access, and more particularly provides a player device enabling fast deletion and access which enables fast updating of data within a digital billboard within a preset time. Moreover, if a user wants to stop the update process within the preset time, then a USB (Universal Serial Bus) connector connected to the present invention need only be pulled out from the digital billboard to stop operation of the present invention and restore the preceding operational situation.

(b) Description of the Prior Art

Advertisements are omnipresent in the lives of people, with advertising/promotional media including newspapers and magazines, circulars, and the like. Moreover, advertisements are enormously influential, so much so that that they affect the lives of people. Nonetheless, technological progress has brought about the gradual lack of interest in traditional advertising/promotional methods, which have been replaced by electronic advertising. Electronic advertising is not only economical on resources, but also environmentally friendly, while at the same time provides advertising/promotional effectiveness. More specifically, website advertising and emails were the forerunners of electronic advertising, and such advertising/promotional methods are not simply word advertisements, but also include images or animation techniques to realize advertising/promotional effectiveness, thereby enabling people to more clearly understand the contents of the advertisements.

Nevertheless, although the aforementioned methods are able to achieve adverting/promotional effectiveness, however, outdoor advertisements rely on advertisement billboards, which can be installed on outdoor walls. The surface area of billboards is large, easily attracting attention, and thus frequently used by advertising companies for important advertisements. However, the majority of such large-scale advertisement billboards are high suspending structures, thus replacement of the billboard contents requires using ladders or a crane to enable the billboard advertisement to be manually taken down and replaced with a new advertisement, which is extremely troublesome. Hence, traditional type advertisement billboards have been replaced by digital billboards, which can be provided with both animated and static effectiveness, and are extremely captivating. Such digital billboards enable broadcasting current popular movies or the latest news, and billboards with enormous surface area enable hundreds of viewers to simultaneously view and appreciate the contents, thus, the investment return rate is extremely high.

However, the following problems and shortcomings are still in need of improvement when using the aforementioned digital billboards:

Although the digital billboard has facilitated many advertising companies to effect more advertising diversification and styles on the billboard, as well as provide viewers with new visual experiences, however, replacement of the advertisement content requires the advertising companies to use a network or manual means to update the contents of a memory box, which is extremely troublesome.

Hence, it is the desire of the inventor and manufacturers engaged in related art and purpose of the present invention to research, resolve and improve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new player device enabling fast deletion and access of the present invention which enables automatic deletion of multimedia data within a digital billboard, after which new multimedia contents can be stored within the digital billboard.

A primary objective of the present invention lies in: A player device structured to comprise a digital billboard and a storage device. A transmission interlace extends from one side of the digital billboard, one end of the transmission interface is provided with a USB slot, and one end of the storage device is equipped with a USB connector. A circuit board is disposed within the storage device, and the circuit board is equipped with a control unit able to automatically delete and store multimedia files within the digital billboard and a database unit able to store multimedia files. When the storage device is connected to the transmission interface, then multimedia data within the digital billboard is automatically deleted within a preset time, and new multimedia data is stored in the digital billboard. If the user wants to stop updating halfway through the update process, the USB connector of the storage device need only be pulled out to immediately stop the update process and restore the preceding operational situation. According to the art described above, the present invention provides a breakthrough in solving the existing problems of digital billboards of the prior art, including problems requiring using a network to replace multimedia contents or having to replace a memory box to update contents of the digital billboard, and achieves convenient automatic updating of multimedia data within the digital billboard through connection of the storage device to the transmission interface, and eliminates the need for manual update, thereby enabling the present invention to realize the practical advancement of economizing on time and effort.

Another objective of the present invention lies in: Large outdoor digital billboards of the prior art require a worker to climb a ladder in order to update the multimedia data within the digital billboard, which is extremely troublesome and dangerous, while for large-scale models and advertising boxes of digital billboards mounted in a wall for specific customers or large outdoor digital billboards mounted in a wall or a floor, then, a user need only use the player device of the present invention to quickly update, using the transmission interface extending from one side of the digital billboard, the multimedia data within such digital billboards from the ground or at any suitable height, and, moreover, enables automatic updating of the multimedia data without the need for any setting-up procedure, thereby providing extreme convenience and safe.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of a preferred embodiment of the present invention.

FIG. 2 shows a perspective view of the preferred embodiment of the present invention.

FIG. 3 shows an operational schematic view of the preferred embodiment according to the present invention.

FIG. 4 shows a flow chart of the preferred embodiment of the present invention.

FIG. 5 shows an operational schematic view of a preferred embodiment according to the present invention.

### DETAILED DESCRIPTION OF THE PREFERRED EMBODIMENTS

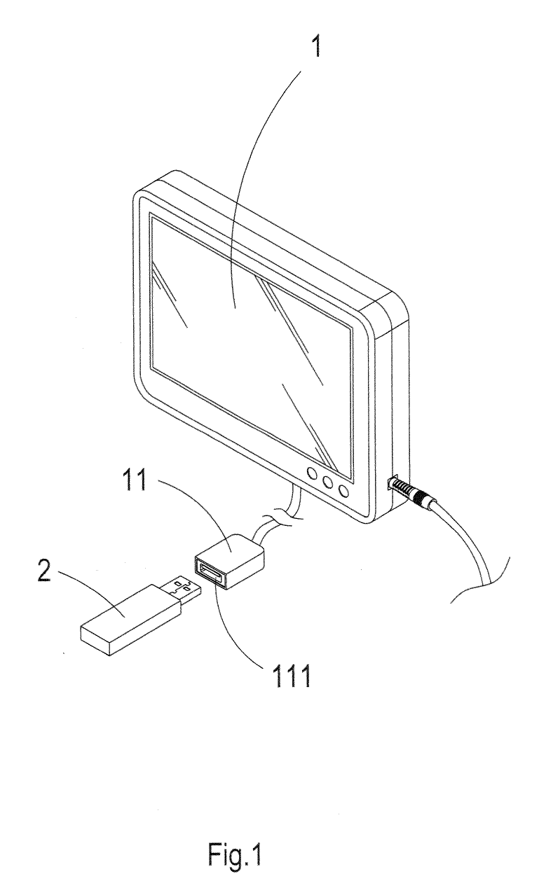

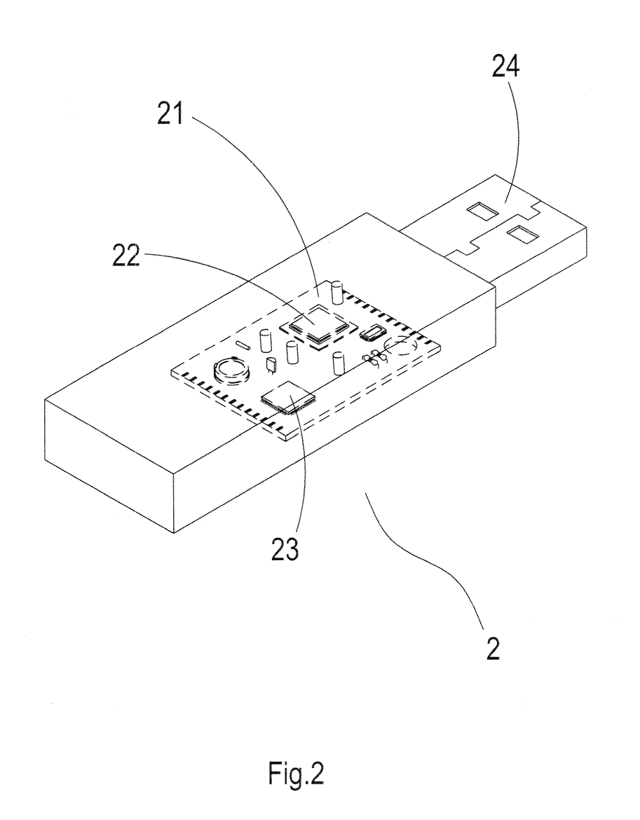

Referring to FIG. 1 and FIG. 2, which show an elevational view and a perspective view respectively of a preferred embodiment of the present invention, and it can be clearly seen from the drawings that the present invention is structured to comprise a digital billboard 1 and a storage device 2. A transmission interface 11 extends from one side of the digital billboard 1, and one end of the transmission interface 11 is provided with a USB slot 111. Moreover, a circuit board 21 is disposed within the storage device 2, and the circuit board 21 is equipped with a control unit 22 able to automatically delete and store multimedia files within the digital billboard 1 and a database unit 23 able to store multimedia files. In addition, one end of the storage device 2 is equipped with a USB connector 24.

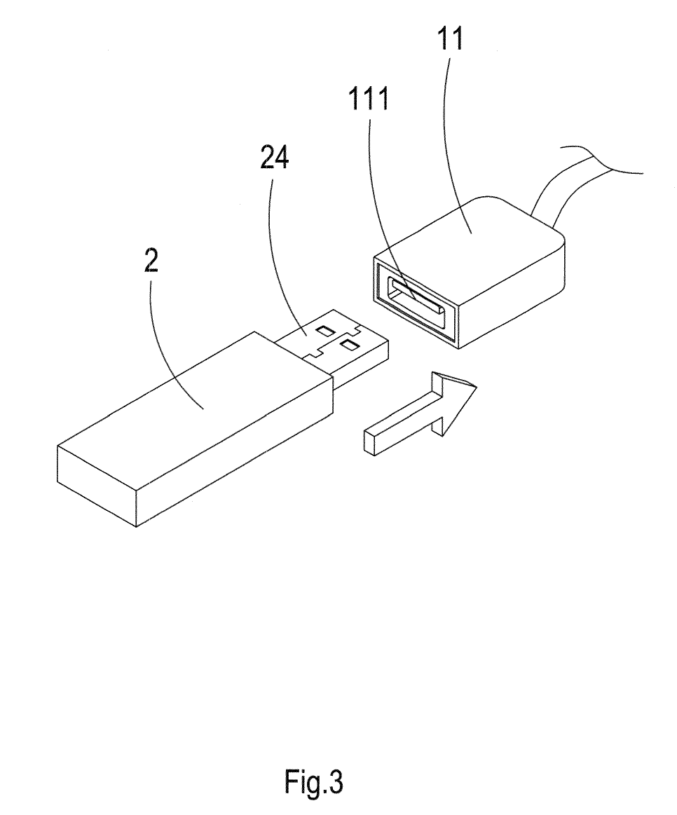

According to the aforementioned structure and constructional design, circumstances during operational use of the present invention are described hereinafter. In conjunction with FIG. 3, which shows an operational schematic view of the preferred embodiment according to the present invention, it can be clearly seen from the drawings that after the user uses the storage device 2 to store new multimedia files by his own accord, then the storage device 2 can be actuated as soon as the USB connector 24 at one end thereof is inserted into the USB slot 111 of the transmission interface 11, thereby enabling the present invention to achieve the objectives of speed, economizing on time and reducing risks.

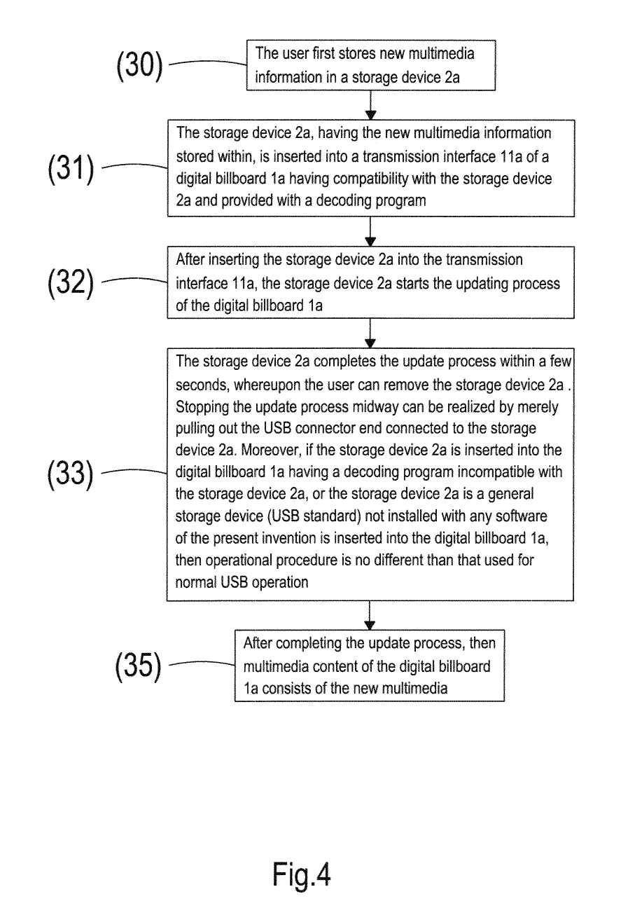

In conjunction with FIG. 4, showing a flow chart of the preferred embodiment according to the present invention, from which the following procedure can be clearly understood:

(30) The user first stores new multimedia information in a storage device 2a;

(31) The storage device 2a, having the new multimedia information stored within, is inserted into a transmission interface 11a of a digital billboard 1a having compatibility with the storage device 2a and provided with a decoding program;

(32) After inserting the storage device 2a into the transmission interface 11a, the storage device 2a starts the updating process of the digital billboard 1a;

(33) The storage device 2a completes the update process within a few seconds, whereupon the user can remove the storage device 2a. Stopping the update process midway can be realized by merely pulling out the USB connector end connected to the storage device 2a. Moreover, if the storage device 2a is inserted into the digital billboard 1a having a decoding program incompatible with the storage device 2a, or the storage device 2a is a general storage device (USB standard) not installed with any software of the present invention is inserted into the digital billboard 1a, then operational procedure is no different than that used for normal USB operation;

(34) After completing the update process, then multimedia content of the digital billboard 1a consists of the new multimedia.

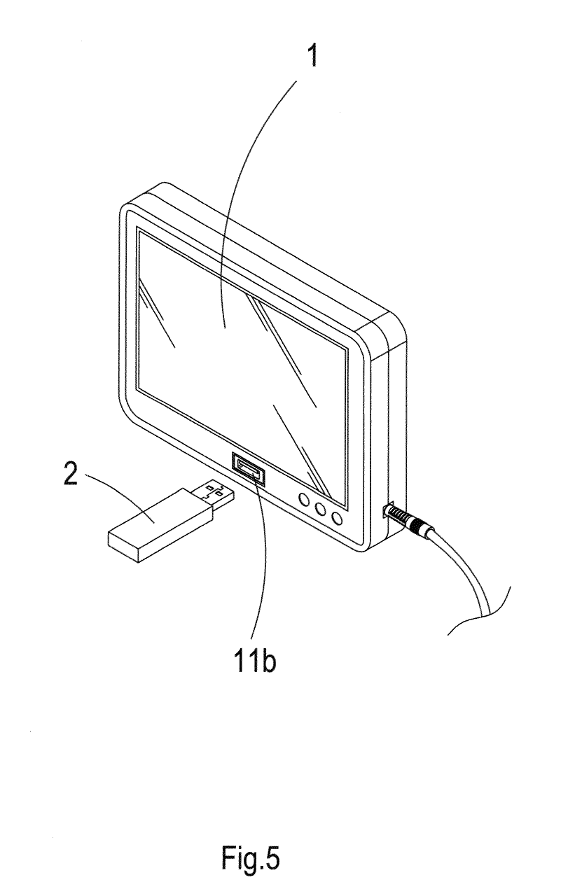

Referring to FIG. 5, which shows an operational schematic view of a preferred embodiment according to the present invention, and it can be clearly seen from the drawings that a transmission interface 11b is further built into one side of the digital billboard 1, thereby enabling the storage device 2 to be inserted therein without the need for an extending element, thus providing an aesthetic function.

Hence, referring to all the drawings, compared to the prior art, the following advantages exist when using the present invention:

The player device of the present invention provides extreme convenience in updating content of the digital billboard 1. Previous updating methods for the digital billboard 1 required using a network connection to update data within the billboard 1, which is inevitably troublesome if the network becomes disconnected. Moreover, the memory box has to be manually replaced when updating large-scale outdoor billboards, which is extremely dangerous.

Characteristics of the present invention include eliminating worry over whether the network is disconnected or incomplete data upload when updating data, as well as eliminating the need to manually erect ladders to replace the memory box, and only requires using the storage device 2 to connect to the transmission interface 11, whereupon old data within a memory box can be automatically deleted and new data inputted and stored, and the storage device 2 can be removed after a preset time to complete the update process, thereby providing extreme ease of use and convenience.

In conclusion, the player device enabling fast deletion and access is clearly able to achieve the effectiveness and objectives of the present invention when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A player device enabling fast deletion and access, comprising:
a digital billboard, a transmission interface extends from one side of the digital billboard;
a storage device, one end of the storage device is equipped with a connector, a circuit board is disposed within the storage device, and the circuit board is equipped with a control unit able to automatically delete and store multimedia files within the digital billboard and a database unit able to store multimedia files.

2. The player device enabling fast deletion and access according to claim 1, wherein one end of the transmission interface is equipped with a USB (Universal Serial Bus) slot.

3. The player device enabling fast deletion and access according to claim 1, wherein the connector is a USB connector.
